(19) United States
(12) Patent Application Publication
(10) Pub. No.: US 2007/0254142 A1
(43) Pub. Date: Nov. 1, 2007

(54) Polymeric webs with nanoparticles

(76) Inventors: Dimitris Ioannis Collias, Mason, OH (US); Norman Scott Broyles, Hamilton, OH (US); Terrill Alan Young, Cincinnati, OH (US); Susan L. Wilking, Hamilton, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(21) Appl. No.: 11/413,542

(22) Filed: Apr. 28, 2006

(51) Int. Cl. A01K 1/015; B32B 5/16; B32B 9/04

(52) U.S. Cl. 428/221; 428/323; 428/411.1; 977/773; 977/775; 977/778; 977/779

(57) ABSTRACT

An expanded polymeric web includes between about 0.1 and about 70 weight percent of a compound comprising nanoparticles. The expanded polymeric web includes between about 30 and about 99.9 weight percent of a generally melt processable polymer. The web also includes between about 0.0 and about 50 weight percent of a compatibilizer. The expanded polymeric web has a 2% machine direction web modulus that is greater than the 2% machine direction web modulus of the expanded polymeric web of the melt processable polymer alone.

### FIELD OF THE INVENTION

The present invention relates to polymeric webs comprising nanoparticles. The invention relates particularly to expanded polymeric webs comprising nanoparticles.

### BACKGROUND OF THE INVENTION

Fillers (also called extenders) are used in the plastics industry (e.g. blow molded bottles, injection molded parts, blown or cast films, and fibers or non wovens) to “fill” the plastic parts. The purpose of the filler can be multifold. The filler can be used to replace plastic at lower cost thus improving the overall cost structure of the parts. The filler can also be used for performance related reasons such as stiffening, creating porosity, altering surface properties, etc. Typical examples of fillers are clays (natural and synthetic), calcium carbonate (CaCO₃), talc, silicate, glass microspheres (solid or hollow), ceramic microspheres, glass fibers, carbon-based materials (platelets, irregular, and fibril), etc.

To achieve their function, fillers need to be dispersed homogeneously in the polymer matrix and have optimal adhesion with the polymer matrix. These properties of homogeneous dispersion and optimal adhesion are achieved with good dispersive and distributive mixing and surface modification of the filler particles, such as coating of the surface of calcium carbonate fillers with stearic acid. Also, the surface modification alters the surface energy of some of the fillers, thus allowing optimal mixing with the polymer matrix. The typical size of the individual filler particles is on the order of μm or tens of μm, which results in <1 m²/g specific surface area available for interaction with the polymer matrix. This small specific surface area may explain the limited benefits typically seen with fillers.

Using a filler material having a greater surface area per gram of material may positively impact the performance to weight ratio of parts.

Expanded polymeric webs have great utility especially in the consumer products area. An important subsection of expanded polymeric webs is ring rolled polymeric webs which find application in many areas such as breathable backsheets for baby care products. The ring rolling is done as is typically known in the art. The stiffness of the ring rolled films can be quantified by web modulus measurements. A higher web modulus generally implies a stiffer film that can allow for lightweighting of the ring rolled film, via thickness reduction, and/or better handling of the ring rolled film in the various manufacturing steps.

In general, the ability to improve the characteristics of the expanded polymeric web is desired.

### SUMMARY OF THE INVENTION

In one aspect, a ring rolled polymeric web consists of between about 0.1 and about 70 weight percent of a compound comprising nanoparticles, between about 30 and about 99.9 weight percent of a generally melt processable polymer, and between about 0.0 and about 50 weight percent of a compatibilizer. The expanded polymeric web has been expanded by ring rolling a base polymeric web, and has a 2% machine direction web modulus that is greater than the 2% machine direction web modulus of an expanded polymeric web of the melt processable polymer alone.

In another aspect, an expanded polymeric web consists of between about 0.1 and about 70 weight percent of a nanoclay, between about 30 and about 99.9 weight percent of a linear low density polyethylene (LLDPE), and between about 0.0 and about 50 weight percent of a compatibilizer. The expanded polymeric web has been expanded by ring rolling a base polymeric web, and has a 2% machine direction web modulus that is greater than the 2% machine direction web modulus of an expanded polymeric web of the linear low density polyethylene alone.

In yet another aspect, an expanded polymeric web consists of between about 1 and about 10 weight percent of an organically-treated nanoclay material, between about 30 and about 50 weight percent of a linear low density polyethylene, and between about 40 and about 60 weight percent of a calcium carbonate. The expanded polymeric web has been expanded by ring rolling a base polymeric web, and has a 2% machine direction web modulus that is at least 30% greater than the 2% machine direction web modulus of an expanded polymeric web of the linear low density polyethylene and calcium carbonate alone.

In still yet another aspect, an expanded polymeric web consists of between about 2 and about 4 weight percent of an organically-treated nanoclay material, between about 35 and about 45 weight percent of a linear low density polyethylene, and between about 50 and about 60 weight percent of a calcium carbonate. The expanded polymeric web has been expanded by ring rolling a base polymeric web, and has a 2% machine direction web modulus that is at least 30% greater than the 2% machine direction web modulus of an expanded polymeric web of the linear low density polyethylene and calcium carbonate alone.

In even yet another aspect, an expanded polymeric web consists of about 2.4 weight percent of an organically-treated nanoclay material, about 40 weight percent of a linear low density polyethylene, and about 55 weight percent of a calcium carbonate. The expanded polymeric web has been expanded by ring rolling a base polymeric web, and has a 2% machine direction web modulus that is at least 30% greater than the 2% machine direction web modulus of an expanded polymeric web of the linear low density polyethylene and calcium carbonate alone.

### DETAILED DESCRIPTION OF THE INVENTION

Unless stated otherwise, all weight percentages are based upon the weight of the polymeric web as a whole. All exemplary listings of web constituents are understood to be non-limiting with regard to the scope of the invention.

As used herein, the term “expanded polymeric web” and its derivatives refer to a polymeric web formed from a precursor polymeric web or film (equivalently called “base polymeric web” or “base polymeric film” herein) that has been ring rolled.

As used herein, the term “2% machine direction web modulus” and its derivatives refer to the machine direction tensile modulus per unit width at 2% strain, measured as the ratio of the differences in stress values at 2.5% and 1.5% and strain values of 2.5% and 1.5%. The test procedure involves a test speed of 10 in./min (25.4 cm/min), web width of 20 in. (50.8 cm), and web length of 20 in. (50.8 cm). The web is rolled up around a stainless steel rod with 1 cm diameter, stapled at the top and bottom, and then tested.

In one embodiment, an expanded polymeric web comprises between about 0.1 and about 70 weight percent of a compound comprising nanoparticles. Nanoparticles are discrete particles comprising at least one dimension in the nanometer range. Nanoparticles can be of various shapes, such as spherical, fibrous, polyhedral, platelet, regular, irregular, etc. In another embodiment, the lower limit on the percentage by weight of the compound may be about 1 percent. In still another embodiment, the lower limit may be about 2 percent. In yet another embodiment, the lower limit may be about 3 percent. In still yet another embodiment, the lower limit may be about 4 percent. In another embodiment, the upper limit may be about 50 percent. In yet another embodiment, the upper limit may be about 30 percent. In still another embodiment, the upper limit may be about 25 percent. The amount of the compound present in the polymeric web may be varied depending on the target product cost and expanded polymeric web properties. Non-limiting examples of nanoparticles are natural nanoclays (such as kaolin, talc, bentonite, hectorite, nontmorillonite, vermiculite, and mica), synthetic nanoclays (such as Laponite® from Southern Clay Products, Inc. of Gonzales, Tex.; and SOMASIF from CO-OP Chemical Company of Japan), treated nanoclays (such as organically-treated nanoclays), nanofibers, metal nanoparticles (e.g. nano aluminum), metal oxide nanoparticles (e.g. nano alumina), metal salt nanoparticles (e.g. nano calcium carbonate), carbon or inorganic nanostructures (e.g. single wall or multi wall carbon nanotubes, carbon nanorods, carbon nanoribbons, carbon nanorings, carbon or metal or metal oxide nanofibers, etc.), and graphite platelets (e.g. expanded graphite, etc.).

In one embodiment, the compound comprising nanoparticles comprises a nanoclay material that has been exfoliated by the addition of ethylene vinyl alcohol (EVOH) to the material. As a non-limiting example, a nanoclay montmorillonite material may be blended with EVOH (27 mole percent ethylene grade). The combination may then be blended with an LLDPE polymer and the resulting combination may be blown or cast into films. The combination of LLDPE, EVOH and nanoclay materials has been found to possess a substantially higher tensile modulus than the base LLDPE, and substantially similar tensile toughness as LLDPE.

The compound comprising nanoparticles may comprise nanoclay particles. These particles consist of platelets that may have a fundamental thickness of about 1 nm and a length or width of between about 100 nm and about 500 nm. In their natural state these platelets are about 1 to about 2 nm apart. In an intercalated state, the platelets may be between about 2 and about 8 nm apart. In an exfoliated state, the platelets may be in excess of about 8 nm apart. In the exfoliated state the specific surface area of the nanoclay material can be about 800 m²/g or higher. Exemplary nanoclay materials include montmorillonite nanoclay materials and organically-treated montmorillonite nanoclay materials (i.e., montmorillonite nanoclay materials that have been treated with a cationic material that imparts hydrophobicity and causes intercalation), and equivalent nanoclays as are known in the art. Such materials are available from Southern Clay Products, Inc. of Gonzales, Tex. (e.g. Cloisite® series of nanoclays); Elementis Specialties, Inc. of Hightstown, N.J. (e.g. Bentone® series of nanoclays); Nanocor, Inc. of Arlington Heights, Ill. (e.g. Nanomer® series of nanoclays); and Süd-Chemie, Inc. of Louisville, Ky. (e.g. Nanofil® series of nanoclays).

The expanded polymeric web also comprises between about 30 and about 99.9 percent of a melt processable polymer. The melt processable polymer may consist of any such melt processable thermoplastic material or their blends. Exemplary melt processable polymers include low density polyethylene, such as ExxonMobil LD129.24 low density polyethylene available from the ExxonMobil Company, of Irving, Tex.; linear low density polyethylene, such as Dowlex™ 2045A and Dowlex™ 2035 available from the Dow Chemical Company, of Midland, Mich.; and other thermoplastic polymers as are known in the art (e.g. high density polyethylene—HDPE; polypropylene—PP; very low density polyethylene—VLDPE; ethylene vinyl acetate—EVA; ethylene methyl acrylate—EMA; EVOH, etc). Furthermore, the melt processable thermoplastic material may comprise typical additives (such as antioxidants, antistatics, nucleators, conductive fillers, flame retardants, pigments, plasticizers, impact modifiers, etc.) as are known in the art. The weight percentage of the melt processable polymer present in the polymeric web will vary depending upon the amount of the compound comprising nanoparticles and other web constituents present in the polymeric web.

The expanded polymeric web may further comprise a compatibilizer in the range from about 0 to about 50 percent by weight. The compatibilizer may provide an enhanced level of interaction between the nanoparticles and the polymer molecules. Exemplary compatibilizers include maleic anhydride, and maleic-anhydride-modified polyolefin as these are known in the art (e.g. maleic-anhydride-grafted polyolefin).

The nanoclay (typically organically-treated nanoclay) and compatibilizer may be provided as a masterbatch that may be added to the polymeric web as a single component. Exemplary examples include the NanoBlend™ materials supplied by PolyOne Corp. of Avon Lake, Ohio, and Nanofil® materials supplied by Süd-Chemie, Inc. of Louisville, Ky.

The precursor polymeric web may comprise materials that induce breathability in the polymeric web upon ring rolling. Non limiting examples of these materials are inorganic or polymeric particles. Calcium carbonate is the most common inorganic particulate used to induce breathability in the polymeric web. In one embodiment, the lower limit on the percentage by weight of the calcium carbonate may be about 5%. In another embodiment, the lower limit on the percentage by weight of the calcium carbonate may be about 10%. In yet another embodiment, the lower limit on the percentage by weight of the calcium carbonate may be about 30%. In still yet another embodiment, the lower limit on the percentage by weight of the calcium carbonate may be about 40%. In one embodiment, the upper limit on the percentage by weight of the calcium carbonate may be about 80%. In another embodiment, the upper limit on the percentage by weight of the calcium carbonate may be about 60%. In yet another embodiment, the upper limit on the percentage by weight of the calcium carbonate may be about 40%. In still yet another embodiment, the upper limit on the percentage by weight of the calcium carbonate may be about 30%.

The precursor polymeric web may be formed using any method known in the art, including, without limitations, casting or blowing the polymeric web. Also, the precursor polymeric web may comprise a single layer or multiple layers.

In one embodiment, the polymeric web may be expanded by ring rolling the web as is known in the art. As an example, and without limiting the invention, a polymeric web comprising about 43% LLDPE, about 40% CaCO₃, and about 4% organically-treated nanoclay particles was ring rolled in a ring rolling apparatus with a roll pitch of 0.060 inches (about 1.5 mm) and a depth of engagement of about 0.075 inches (about 1.9 mm). The 2% machine direction web modulus of the expanded web was found to be about 50% greater than the 2% machine direction web modulus of a similarly ring rolled web without the organically-treated nanoclay particles. Also, the 2% machine direction web modulus of a flat polymeric web (i.e., not ringed rolled) with the same composition as the ring rolled polymeric web above was found to be only about 10% greater than the 2% machine direction web modulus of a similar flat polymeric web without the organically-treated nanoclay particles.

Product examples:

The expanded polymeric web materials of the invention may be utilized in any application where a ring rolled web would be beneficial. The requirements of the intended use may be associated with the particular composition of the web and also with the method of expanding the web material.

In one embodiment, a disposable absorbent product may comprise a ring rolled web comprising nanoclay particles and optionally comprising CaCO₃. The ring rolled web material may be utilized as an element of the product to provide an extensible element without the need to include rubber compounds in the element. The material may be ring rolled using the apparatus and methods for ring rolling films as these are known in the art.

The expanded polymeric web materials described may be utilized as elements of other products as well as the uses set forth above. Exemplary uses for the expanded polymeric webs include, without limiting the invention, film wraps, bags, polymeric sheeting, outer product coverings, packaging materials, and combinations thereof.

The expanded polymeric web materials may be incorporated into products as direct replacements for otherwise similar web materials which do not comprise nanoparticles.

All documents cited in the Detailed Description of the Invention are, in relevant part, incorporated herein by reference; the citation of any document is not to be construed as an admission that it is prior art with respect to the present invention. To the extent that any meaning or definition of a term in this written document conflicts with any meaning or definition of the term in a document incorporated by reference, the meaning or definition assigned to the term in this written document shall govern.

While particular embodiments of the present invention have been illustrated and described, it would have been obvious to those skilled in the art that various other changes and modifications can be made without departing from the spirit and scope of the invention. It is therefore intended to cover in the appended claims all such changes and modifications that are within the scope of the invention.

What is claimed is:

1. An expanded polymeric web comprising:
a) between about 0.1 and about 70 weight percent, of a compound comprising nanoparticles,
b) between about 30 and about 99.9 weight percent of a generally melt processable polymer, and
c) between about 0.0 and about 50 weight percent of a compatibilizer,
wherein the expanded polymeric web has been expanded by ring rolling a base polymeric web, and has a 2% machine direction web modulus that is greater than the 2% machine direction web modulus of an expanded polymeric web of the melt processable polymer alone.

2. The expanded polymeric web according to claim 1 comprising between about 10 and about 60 weight percent of calcium carbonate.

3. The expanded polymeric web according to claim 1 wherein the base polymeric web is a cast film.

4. The expanded polymeric web according to claim 1 wherein the base polymeric web is a blown film.

5. The expanded polymeric web according to claim 1 wherein the melt processable polymer comprises a linear low density polyethylene.

6. The expanded polymeric web according to claim 5 wherein the linear low density polyethylene comprises a low density polyethylene.

7. The expanded polymeric web according to claim 1 wherein the compound comprises a nanoclay material.

8. The expanded polymeric web according to claim 7 wherein the nanoclay material comprises organically-treated montmorillonite nanoclay material.

9. An expanded polymeric web comprising:
a) between about 0.1 and about 70 weight percent of a nanoclay,
b) between about 30 and about 99.9 weight percent of a linear low density polyethylene, and
c) between about 0.0 and about 50 weight percent of a compatibilizer,
wherein the expanded polymeric web has been expanded by ring rolling a base polymeric web, and has a 2% machine direction web modulus that is greater than the 2% machine direction web modulus of an expanded polymeric web of the linear low density polyethylene alone.

10. The expanded polymeric web according to claim 9 comprising between about 10 and about 60 weight percent of calcium carbonate.

11. The expanded polymeric web of claim 9 wherein the base polymeric web is a cast film.

12. The expanded polymeric we of claim 9 wherein the base polymeric web is a blown film.

13. The expanded polymeric web according to claim 9 wherein the linear low density polyethylene material comprises a low density polyethylene.

14. An expanded polymeric web according to claim 9 further comprising:
between about 40 and about 60 weight percent of a calcium carbonate.

15. An expanded polymeric web according to claim 9 further comprising:
between about 50 and about 60 weight percent of a calcium carbonate.

16. An expanded polymeric web according to claim 9 further comprising:
about 55 weight percent of a calcium carbonate.

17. A product comprising an expanded polymeric web, the expanded polymeric web comprising:
a) between about 0.1 and about 70 weight percent, of a compound comprising nanoparticles,
b) between about 30 and about 99.9 weight percent of a generally melt processable polymer, and
c) between about 0.0 and about 50 weight percent of a compatibilizer,
wherein the web material comprises a ring rolled base web and the web material has a machine direction modulus which is greater than the machine direction modulus of the base web.
